(19) United States
(12) Patent Application Publication
(10) Pub. No.: US 2026/0032474 A1
(43) Pub. Date: Jan. 29, 2026

(54) NETWORK MEASUREMENT DEVICE WITH COMBINED RECEIVERS

(71) Applicant: Ekahau Oy, Helsinki (FI)

(72) Inventors: Ari TOURUNEN, Espoo (FI); Mikko LAURONEN, Helsinki (FI)

(21) Appl. No.: 18/996,831

(22) PCT Filed: Jun. 16, 2023
(86) PCT No.: PCT/FI2023/050360

§ 371 Date: Jan. 17, 2025

Related U.S. Application Data
(60) Provisional application No. 63/392,037, filed on Jul. 25, 2022.

(51) Int. Cl. H04W 24/08; H04W 64/00; H04W 84/12

(52) U.S. Cl. CPC H04W 24/08; H04W 64/00; H04W 84/12

(57) ABSTRACT

A device (100) includes a plurality of antennas (102, 104, 106, 108, 110, 112), a plurality of receivers (114, 116, 118), and a processing device (120). Each receiver is coupled to one or more of the plurality of antennas. The processing device is configured to determine a network signal strength based on a plurality of signal strengths from each of the plurality of receivers, respectively, each of the plurality of signal strengths corresponding to sensing of a common network signal.

### BACKGROUND

A wireless network may include computing devices (e.g., nodes) that communicate with each other using wireless data connections. Each node may have a transmitter or receiver that communicates with the network over radio frequencies (RF). A wireless local area network (WLAN) links two or more devices through an access point. The access point typically connects to a wired router, switch, or hub via an Ethernet cable, and projects a signal (e.g., a Wi-Fi signal) that covers a given region. For example, an access point may be installed in a living room to provide network coverage in the living room and surrounding areas.

A typical wireless network includes a plurality of access points providing wireless access. A variety of network planning tools are available for wireless network planning. Multi-band access points are physical access points that may include multiple radios operating in different frequencies. Using as few physical access points as possible is often a target in network planning to facilitate deployment and maintenance, for example. A network planning tool (e.g., a measurement tool) may be used to determine whether coverage is sufficient at various locations of a given space.

### SUMMARY

This disclosure relates to a network planning tool such as a computing device, that may measure signal strength of a network.

In one aspect, a device includes a plurality of antennas, a plurality of receivers, each receiver coupled to one or more of the plurality of antennas, and a processing device, configured to, in a first mode, determine a network signal strength based on a plurality of signal strengths from each of the plurality of receivers, respectively, each of the plurality of signal strengths corresponding to sensing of a common network signal. The network signal strength may, in some examples, include a signal to noise ratio (SNR). The first mode may be referred to as an accuracy mode.

In some examples, in the first mode, each of the plurality of receivers senses the common network signal at a common frequency range, synchronously. In the first mode, determining the network signal strength may include selecting a strongest of the plurality of signal strengths as the network signal strength at a common frequency range. In the first mode, the processing device may be further configured to sweep a plurality of frequency ranges and determine the network signal strength at each of the plurality of frequency ranges, with the plurality of receivers operating synchronously. In some examples, the device may operate in a second mode. In the second

mode, the processing device may be configured to operate two or more of the plurality of receivers to each independently sense the network signal strength at non-overlapping frequency ranges. The second mode may be referred to as a speed mode.

Each of the plurality of antennas may be fixed on the device with a different position. The device may be a battery powered device (e.g., a cordless or portable device). In some examples, each of the plurality of receivers may be coupled to two of the plurality of antennas.

In some examples, each of the receivers includes a wi-fi receiver that senses the common network signal over a Wi-Fi network. In some examples, the processor is further configured to associate the network signal strength with a location of the device. A heat map of a network signal strength in an environment may be determined based on the overall signal strength at each of a plurality of different locations of the environment.

In one aspect, a method, may be performed by a device. The method may include sensing a plurality of signal strengths with a plurality of receivers, respectively, where each receiver is coupled to one or more of the plurality of antennas, obtaining the plurality of signal strengths from the plurality of receivers, and determining a network signal strength based on the plurality of signal strengths, where each of the plurality of signal strengths corresponds to sensing of a common network signal.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 shows a block diagram of an example computing device for sensing a network signal strength, in accordance with some embodiments.

FIG. 2 shows an example of a computing device, in accordance with some embodiments.

FIG. 3 shows an example of a computing device that measures network coverage, in accordance with some embodiments.

FIG. 4 illustrates a method for determining a network signal strength, in accordance with some embodiments.

FIG. 5 illustrates a method for determining a network signal strength in multiple modes, in accordance with some embodiments.

### DETAILED DESCRIPTION

Wi-Fi utilizes some of the IEEE 802 protocol family and interacts seamlessly with Ethernet, a wired networking technology and standard. Wi-Fi enabled devices can connect to the network through a wireless access point, which may be a multi-band wireless access point. The network provides communication between devices on the network, as well as the Internet. Various versions of Wi-Fi are specified by various IEEE 802.11 protocol standards. The different radio technologies determine the radio bands, the maximum ranges, and the speeds that may be achieved through the network. Wi-Fi may use 2.4 gigahertz (120 mm) UHF and 5 gigahertz (60 mm) SHF radio bands. Wi-Fi has also expanded to 6 gigahertz bands. These bands are subdivided into multiple channels (e.g., frequency ranges). Channels can be shared between networks. Typically, only one transmitter can locally transmit on a channel at any moment in time in the network.

Conventionally, a wireless measurement solution may be limited in accuracy when sensing signal strength of a given channel with only a single antenna. Antennas are imperfect and antenna patterns may vary. For example, an antenna pattern may have gaps or weak reception in certain directions. This imperfection in the antenna pattern may result in inaccuracy in the measured signal strength of a network at a given location. Depending on the direction of the measured signal, or the orientation of the measurement device, the measured network signal strength may vary. Precision is reduced. Various technologies may use a multi-antenna or combined antenna arrangement, such as for Multiple-Input Multiple-Output (MIMO) applications. Such technologies relate to multi-path or multi-stream reception where a single radio receiver typically performs the operations of antenna combining. With such technologies, different antennas and receivers may receive different messages over different channels, or the same message may be received on the same channel with multiple receivers, and then the message may be pieced together using input from the multiple receivers. Such technologies, however, do not provide a network signal strength nor are they designed to do so.

Aspects of the present disclosure may improve the accuracy (e.g., the precision) of a wireless measurement solution, by combining independent radio receivers together to accurately determine a network signal strength. Further, the ability to perform high speed measurements may be maintained in some circumstances, for example, when speed is preferred over accuracy. A device may include two or more radio receivers. Each receiver may include or be coupled to one or more antennas. A processing device may obtain signal measurements from each receiver. When one receiver senses a signal from one signal source (e.g., an access point), another receiver (e.g., the remaining receivers) may be operated to receive the same signal (e.g., on the same channel from the same source). Both of the receivers may be operated by the processing device to measure signal quality (e.g., signal strength) independently. The processing device may apply a combining function that assesses each of the signal measurements from the different receivers and utilizes the measurement having better quality signal. In some embodiments, the processing device selects the strongest signal as the representative of the network signal strength. As the number of receivers and antennas increases, the accuracy of the network signal measurement increases. Unlike typical data communications that may utilize MIMO technology, the processing device does not combine decoded parts of a message received on the same channel (from different receivers), nor do the receivers decode and output different messages received over different channels.

Combining multiple antennas placed in different positions and locations may improve the quality of a sensed radio signal. Even if one antenna receives a poor signal, another might be in better location and direction to sense the signal. Such an approach is not without drawbacks. The more antennas a receiver has, the more complicated the radio receiver becomes. Typically, the primary function of a radio receiver is to receive and decode a signal acceptably, rather than to measure the signal strength with accuracy. As such, the radio receivers are not configured to maximize the signal sensing of each individual antennas connected. In addition, if the radio receiver is designed to receive and decode a large number of antennas, this receiver cannot simultaneously decode many signals at different channels (e.g., frequency ranges). If many antennas are connected to just a single receiver, the ability to tradeoff between speed and accuracy may be lost.

Thus, aspects of the present disclosure use an approach that has a limited number of antennas per receiver and combines several receiver outputs. Optionally, for example, each receiver may be connected to five antennas or less, or three antennas or less, or two antennas or less. This flexible architecture supports measurements for speed (using the receivers asynchronously) in some circumstances, and for accuracy (using the receivers synchronously) in other circumstances. Such an architecture may also be more cost effective than a single receiver with a large number of antennas.

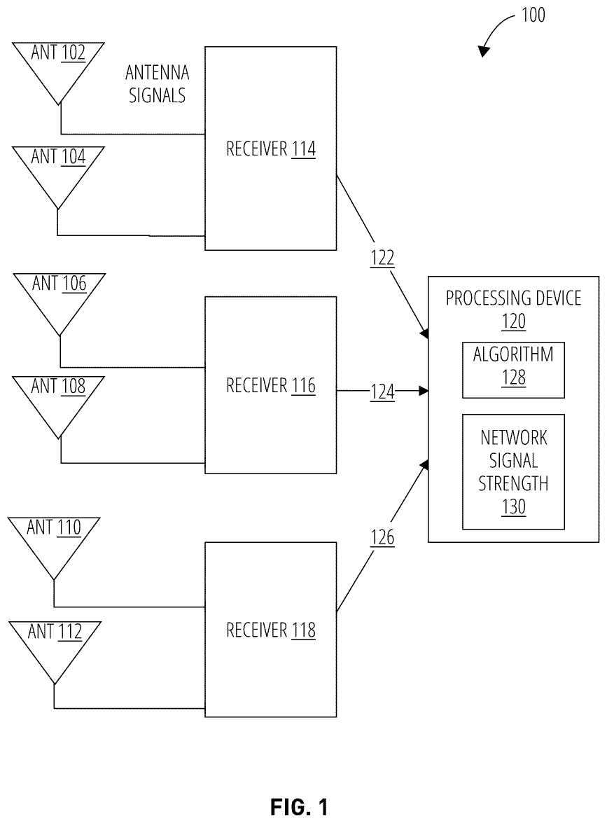

FIG. 1 shows a block diagram of an example computing device 100 and workflow for sensing a network signal strength with combined signal measurements, in accordance with some embodiments. The computing device 100 of this example may be described as operating in a first mode, which may be referred to as an accuracy mode. In such a mode, the receivers are operated to prioritize accuracy over speed.

The device 100 may include a plurality of antennas such as antennas 102, 104, 106, 108, 110, and 112. The device may include a plurality of receivers such as receiver 114, receiver 116, and receiver 118. Each receiver is coupled to one or more of the plurality of antennas. For example, receiver 114 receives antenna signals from antenna 102 and antenna 104. Receiver 116 may receive antenna signals from antenna 106 and antenna 108. Receiver 118 may receive antenna signals from antenna 110 and 112.

Each antenna signal may carry information of the sensed signal, as well as other RF energy in the sensed environment of the device (e.g., other signals). Each receiver may process each received antenna signal, to sense a signal at a given frequency (e.g., through applying signal processing, amplification, filtering, etc.).

The device may include processing device 120, configured to determine a network signal strength 130 based on a plurality of signal strengths (e.g., 122, 124, and 126) from each of the plurality of receivers, respectively. Each of the plurality of signal strengths may correspond to sensing of a common network signal. For example, the common network signal may be the same signal at the same frequency range (e.g., channel) sensed by the different receivers at the same time.

A processing device such as 120 or in other examples, may include processing logic such as hardware (e.g., circuitry, electronic components, passive components, active components, dedicated logic, programmable logic, a processor, a central processing unit (CPU), memory, a system-on-chip (SoC), etc.), software (e.g., instructions running/executing on a processing device), firmware (e.g., microcode), or a combination thereof. Processing device 120 may be standalone within the computing device 242, or distributed through various other components, or both.

Each of the plurality of receivers may sense the common network signal at a common frequency range, synchronously. For example, in the high accuracy mode, receivers 114, 116, and 118 may be operated to simultaneously sense the network signal at frequency range ‘A’. Each receiver independently determines a signal strength based on its antennas. For example, receiver 114 may determine signal strength 122 based on sensing the network signal at frequency range ‘A’ (or channel ‘A’) through antennas 102 and 104. Signal strength 122 may be the strongest of antennas 102 and 104. The receiver 114 may determine the signal strength as a signal to noise ratio. For example, the receiver 114 may measure RF energy that is not from the common network signal (e.g., noise) received in its antennas 102 and 104, and compare that to the signal energy sensed in its antennas to determine the signal strength 122. Each receiver may operate in the same manner to determine the signal strength of the common network signal as sensed in its respective antennas.

Processing device 120 may apply one or more algorithms 128 to the signal strengths 122, 124, and 126, to determine the network signal strength 130. In some embodiments, the algorithm 128 may select a strongest of the plurality of signal strengths as the network signal strength at a common frequency range. For example, if signal strength 122 is X dB, signal strength 124 is X−2 dB, and signal strength 126 is X+5 dB, then algorithm 128 may select signal strength 126 as the network signal strength 130. The network signal strength 130 may correspond to the frequency range that the signal was sensed to be carried in.

Further, each of the receivers may be operated to sweep a plurality of frequency ranges in a synchronous manner. For each of a plurality of frequency ranges (e.g., different channels), the receivers may each determine the signal strength of the same signal, simultaneously, at the same frequency range. Processing device may apply algorithm 128 to determine the corresponding network signal strength 130 for each frequency range.

For example, for a first frequency range, each of the receivers simultaneously determine a corresponding signal strength (122, 124, 126). A network signal strength 130 is determined for that first frequency range based on the individual signal strengths 122, 124, and 126, as described. Processing device 120 may operate the receivers at a second frequency range to simultaneously determine corresponding signal strengths (122, 124, 126) and determine the network signal strength 130 for that second frequency range, based on those signal strengths, and so on. This may be repeated until each of the channels is covered sufficiently. For example, the device may be configured (e.g., by a user, or with default settings, or other techniques) to sweep over a number of specified frequency ranges.

In some examples, each of the plurality of receivers is coupled to one or two of the plurality of antennas. In some examples, each of the plurality of receivers is coupled to at most two antennas. In such a manner, a receiver may also operate in a speed mode, as described in other sections.

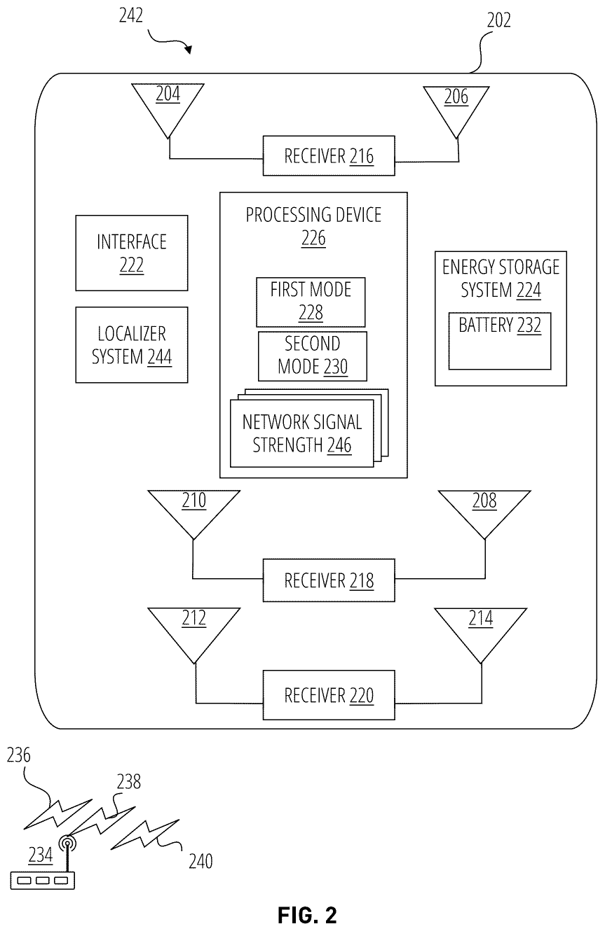

FIG. 2 shows an example of a computing device 242, in accordance with some embodiments. The computing device 242 may perform some or all of the operations or methods described. The computing device 242 may be understood as a network planning tool or as a network measurement device. In some examples, the network measurement device may be a portable measuring device (e.g., a handheld device, or a wearable device).

Computing device 242 may include a housing or enclosure 202 that houses the various components described. Computing device 242 may include two or more receivers (e.g., receivers 216, 218, and 220), a processing device 226, two or more antennas (e.g., antennas 204, 206, 208, 210, 212, 214), as well as other components.

In some examples, the device 242 may include an interface 222 which may include a button, a touchscreen display, a microphone, etc., to receive user inputs. The interface 222 may also connect with remote devices to take user inputs remotely. For example, a user may operate the device with a second device (e.g., a computer, a tablet computer, a mobile phone, etc.) that may provide user inputs (e.g., selecting mode of operation). Interface 222 may include a wired or wireless port to communicate from device 242 to an external device. For example, device 242 may communicate information (e.g., network signal strength) gathered by the measuring device, or be used to update the settings of the device 242, or otherwise interact with external devices.

The device may include a localizer system 244 that may determine a location of the computing device 242. The localizer system 244 may include Wi-Fi position system (WPS) technology which utilizes sensed characteristics (e.g., signal strength) of various access points and known locations of each access point to determine a location of the computing device. Additionally, or alternatively, the localizer system 244 may include global positioning system (GPS) to determine the location of the computing device. The location of the device may be used in association with the sensed network signal strength 246 to map out the network signal strength at various locations in a region of interest.

In some examples, the computing device 242 is a battery powered device. The device may include an energy storage system 224 which may include one or more batteries 232 that power the various components of the computing device 242. The computing device 242 may be a cordless device so that a user may carry the device freely throughout a given space and measure the network signal strength at various locations.

Although not shown, the device may include one or more printed circuit boards and other electronic components connected to the circuit boards. Some of the components may be integral to or distributed throughout other components.

The processing device 226 may be configured to operate the device in a plurality of modes. The processing device 226 may determine which mode to operate in based on a setting (e.g., a default setting), user input (e.g., from interface 222), or other input or combination thereof.

The processing device 226 may be configured to, in a first mode 228, determine a network signal strength 246 based on a plurality of signal strengths from each of the plurality of receivers. As described in other sections, each receiver may determine a signal strength that correspond to a common network signal (e.g., signal 236). Each of the plurality of receivers may sense the common network signal 236 which may be transmitted by an access point 234 at a common frequency range, synchronously (e.g., simultaneously). A single network signal strength 246 may be determined based on these each of these individual signal strengths from the asynchronously working receivers. The processing device may apply different algorithms in the first mode to combine the individual signal strengths and determine the network signal strength.

For example, processing device 226 may select a strongest of the plurality of signal strengths as the network signal strength 246. This network signal strength corresponds to the common frequency range at which each of the plurality of signal strengths is measured. As such, at a given time, each of the receivers work in unison to determine the network signal strength 246 of the same frequency range (e.g., a channel).

In the first mode 228, the processing device may operate the receivers to sweep a plurality of frequency ranges and determine the network signal strength at each of the different plurality of frequency ranges, with the plurality of receivers operating synchronously. For example, after determining a first network signal strength 246 for signal 236, the receivers may be operated to simultaneously sense and determine a signal strength for signal 238 which is transmitted over a different frequency range from that of signal 236. The processing device 226 may determine a second network signal strength 246 for signal 238 based on the signal strengths determined at each receiver for signal 238. This may be repeated for each frequency range of interest to determine a plurality of network signal strengths 246. This may further be repeated at various locations of interest to build a profile or a heatmap of the network coverage over a region of interest.

In such a manner, multiple receivers, using their respective antennas, may be operated to sense the same signal (e.g., at a common frequency range), thereby improving the accuracy of the network signal strength measurement for that signal. As discussed, however, there may be circumstances when speed is valued over accuracy. In such a circumstance, it may be beneficial to sense multiple signals (across different frequency ranges) simultaneously. In this regard, the processing device 226 may operate the device 242 in a second mode 230, which may be referred to as a speed mode.

In the second mode 230, the processing device may operate two or more of the plurality of receivers to each independently sense the network signal strength at non-overlapping frequency ranges. This may be understood as asynchronous operation of the receivers.

For example, in the second mode, receiver 216 may be operated to sense signal strength of signal 236 over frequency range A. Receiver 218 may sense signal strength of signal 238 over a different frequency range B. Receiver 220 may sense signal strength of signal 240 over frequency range C.

Processing device 226 may treat each sensed signal strength as the network signal strength 246 of that signal (or of that frequency range). This may be performed simultaneously, so that the device 242 may measure network signal strength 246 of signals 236, 238, and 240 simultaneously, with different receivers. Although accuracy may be lower compared to the first mode, the second mode may sweep across the same number of frequency ranges in a shorter time. By operating under different modes, computing device 242 allows users to perform measurements with improved accuracy if time is not an issue, or perform measurements faster (with reduced accuracy) if time is of the essence.

Each of the plurality of antennas may be housed on or within the device housing 202. Each antenna may be fixed on the device 242 with a different position (e.g., with a unique direction and/or location). Each of the receivers may include a Wi-Fi receiver (e.g., a Wi-Fi compatible receiver) that senses the common network signal (e.g., signal 236, 238, or 240) over a Wi-Fi network. The receivers may be compatible with WLAN standards 802.11n, 802.11g, 802.11b and 802.11a, so they may be used to measure information in networks of the corresponding standards. In other embodiments, the receivers may be compatible with another standard.

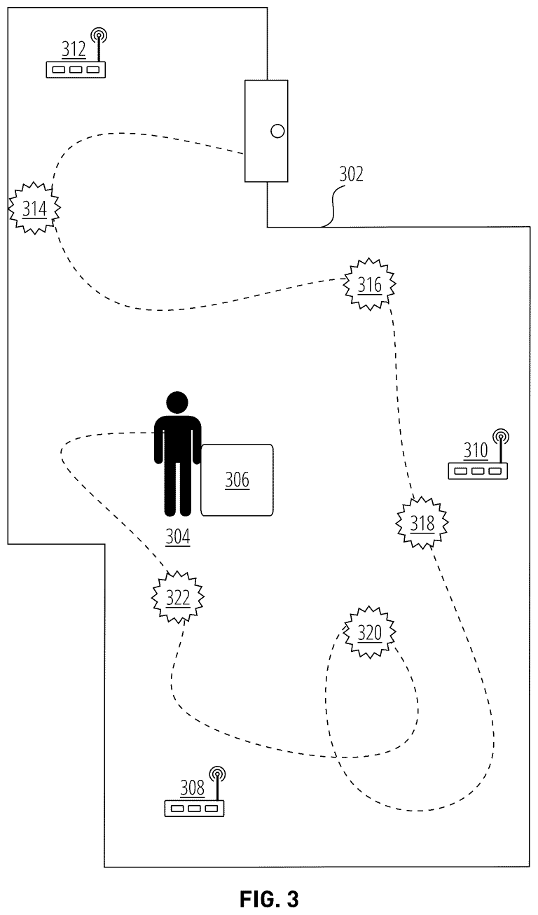

FIG. 3 shows an example of a network measurement device 306 that measures network coverage, in accordance with some embodiments. The network measurement device 306 may correspond to a computing device as described in other examples.

A user 304 may operate measurement device 306 to scan the network coverage at various locations in a region 302 of interest. The region 302 may be an indoor space, an outdoor space, or both. The region may include one or more access points such as access points 308, 310, and 312. The access points may be multi-band access points.

In some embodiments, a user may initiate operation (e.g., scanning and measuring of signals) through one or more user inputs (e.g., a button press, etc.). Additionally, or alternatively, the device 306 may operate without user input (e.g., scanning periodically or in response to sensed movement or location, or a combination thereof).

Regardless of how the scan is initiated, the device may sense signal strength at various channels of interest at a given location. For example, at location 314, the device may determine a network signal strength of the network for each frequency range. The user may move to a second location 316 where another set of network signal strengths is determined. The user may repeat this over various locations in region 302 such as locations 318, 320, and 322, until the region is sufficiently measured. Depending on the various network signal strengths measured, the user may add or move access points to cover areas with a weak signal strength, or remove an access point where coverage is sufficient.

In some embodiments, device 306 may associate the network signal strength with a location of the device. For example, one or more network signal strengths that are determined at location 314 may be tagged with metadata indicating location 314 (e.g., as coordinates, or a location ID, etc.) and saved in computer-readable memory. The network signal strengths and metadata may be stored locally, or on a remote device, or both. The network signal strengths determined at each of the locations (e.g., 316, 318, 320, and 322) may be stored along with the location at which that network signal strength is measured to provide a mapping between signal strength and various locations in the region 302.

In some examples, a heat map of a network signal strength in an environment is determined based on the overall signal strength at each of a plurality of different locations of the environment. A heat map may provide a visual indication such as variations in brightness, color, or other visual indicator which may be overlaid on a map of the region of interest, to show strength of the network signal at various locations on the map. The heat map may be presented to a display, which may be integral to the device or a remote display.

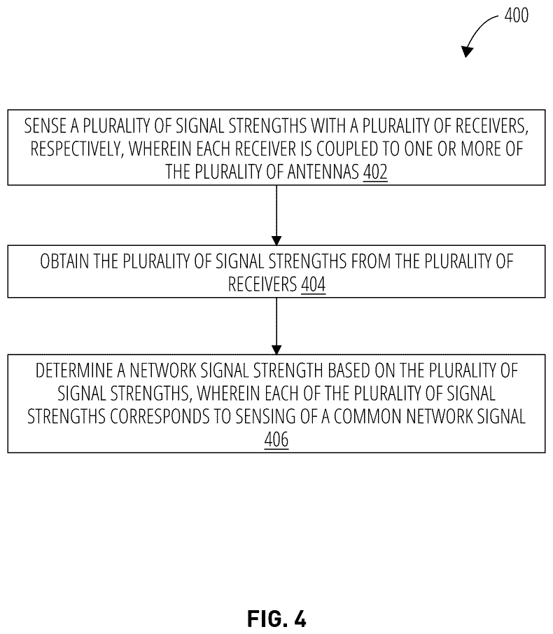

FIG. 4 illustrates a method 400 for determining a network signal strength, in accordance with some embodiments. The method may be performed with various aspects described. The method may be performed by processing logic of a measuring device. Processing logic may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Although specific function blocks (“blocks”) are described in the method, such blocks are examples. That is, aspects are well suited to performing various other blocks or variations of the blocks recited in the method. It is appreciated that the blocks in the method may be performed in an order different than presented, and that not all of the blocks in the method may be performed.

The method 400 may be performed by processing logic of a computing device operating in a high accuracy mode, with the plurality of receivers working synchronously, as discussed in other sections.

At block 402, processing logic senses a plurality of signal strengths with a plurality of receivers, respectively, wherein each receiver is coupled to one or more of the plurality of antennas. At block 404, processing logic obtains the plurality of signal strengths from the plurality of receivers. At block 406, processing logic determines a network signal strength based on the plurality of signal strengths, wherein each of the plurality of signal strengths corresponds to sensing of a common network signal.

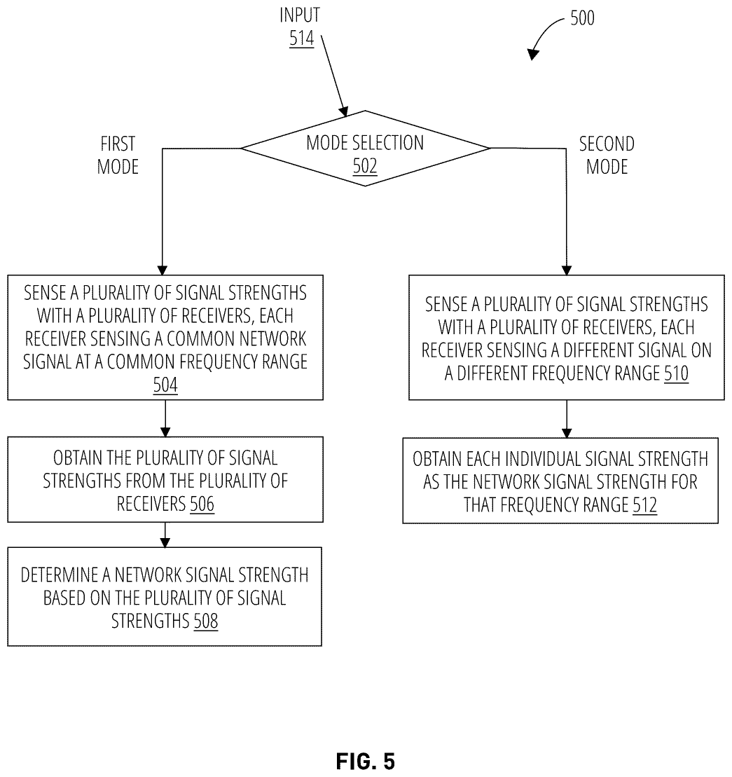

FIG. 5 illustrates a method 500 for determining a network signal strength in multiple modes, in accordance with some embodiments. The method may be performed with various aspects described. The method may be performed by processing logic of a measuring device. Processing logic may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Although specific function blocks (“blocks”) are described in the method, such blocks are examples. That is, aspects are well suited to performing various other blocks or variations of the blocks recited in the method. It is appreciated that the blocks in the method may be performed in an order different than presented, and that not all of the blocks in the method may be performed.

At decision block 502, processing logic may determine whether to operate in a first mode (e.g., an accuracy mode) or a second mode (e.g., a speed mode). This may be determined based on input 514. Input 514 may include a user input (e.g., a selection), a user setting (e.g., a user preference), a default setting, or other input.

Processing logic may proceed to block 504 (e.g., the first mode) in response to input 514. At block 504, processing logic may sense a plurality of signal strengths with a plurality of receivers, each receiver sensing a common network signal at a common frequency range. At block 506, processing logic may obtain the plurality of signal strengths from the plurality of receivers. At block 508, processing logic may determine a network signal strength based on the plurality of signal strengths. In such a manner, the method may take a high accuracy approach to measuring network signal strength using each of the antennas and receivers in a synchronous manner.

In other circumstances, input 514 may indicate to proceed to block 510 (e.g., the second mode). At block 510, processing logic may sense a plurality of signal strengths with a plurality of receivers, each receiver sensing a different signal on a different frequency range. The receivers may operate asynchronously. At block 512, processing logic may obtain each individual signal strength from each receiver as the network signal strength for that frequency range. In such a manner, processing logic may obtain the network signal strength across the spectrum of frequency ranges in a short period of time (e.g., faster than with the first mode).

Some portions of the preceding detailed descriptions have been presented in terms of algorithms and symbolic representations of operations on data bits within a computer memory. These algorithmic descriptions and representations are the ways used by those skilled in the arts to convey the substance of their work most effectively to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computing device, that manipulates and transforms data represented as physical (electronic) quantities within the system's registers and memories into other data similarly represented as physical quantities within the system memories or registers or other such information storage, transmission or display devices.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

While certain aspects have been described and shown in the accompanying drawings, it is to be understood that such aspects are merely illustrative of and not restrictive, and the disclosure is not limited to the specific constructions and arrangements shown and described, since various other modifications may occur to those of ordinary skill in the art.

1. A device comprising:
a plurality of antennas,
a plurality of receivers, each receiver coupled to one or more of the plurality of antennas; and
a processing device, configured to determine a network signal strength based on a plurality of signal strengths from each of the plurality of receivers comprised in the device, each of the plurality of signal strengths corresponding to sensing of a common network signal.

2. The device of claim 1, wherein each of the plurality of receivers senses the common network signal at a common frequency range, synchronously.

3. The device claim 1, wherein to determine the network signal strength includes to select a strongest of the plurality of signal strengths as the network signal strength at a common frequency range.

4. The device of claim 1, wherein in the processing device is further configured to sweep a plurality of frequency ranges and determine the network signal strength at each of the plurality of frequency ranges, with the plurality of receivers operating synchronously.

5. The device of claim 1, wherein the processing device is configured to, in a second mode, operate two or more of the plurality of receivers to each independently sense the network signal strength at non-overlapping frequency ranges.

6. The device of claim 1, wherein the network signal strength includes a signal to noise ratio (SNR).

7. The device of claim 1, wherein each of the plurality of antennas is fixed on the device with a different position.

8. The device of claim 1, wherein the device is a battery powered device.

9. The device of claim 1, wherein each of the plurality of receivers is coupled to two of the plurality of antennas.

10. The device of claim 1, wherein each of the receivers includes a wi-fi receiver that senses the common network signal over a wi-fi network.

11. The device of claim 1, wherein the processing device is further configured to associate the network signal strength with a location of the device.

12. The device of claim 1, wherein a heat map of a network signal strength in an environment is determined based on the network signal strength at each of a plurality of different locations of the environment.

13. A method, performed by a device, comprising:
sensing a plurality of signal strengths with a plurality of receivers, respectively, wherein each receiver is coupled to one or more of a plurality of antennas, wherein the plurality of receivers and the plurality of antennas are comprised in the device;
obtaining the plurality of signal strengths from the plurality of receivers; and
determining a network signal strength based on the plurality of signal strengths, wherein each of the plurality of signal strengths corresponds to sensing of a common network signal.

14. The method of claim 13, wherein each of the plurality of receivers senses the common network signal at a common frequency range, synchronously.

15. The method of claim 13, wherein determining the network signal strength includes to select a strongest of the plurality of signal strengths as the network signal strength at a common frequency range.

16. The method of claim 13, further comprising: sweeping a plurality of frequency ranges and determine the network signal strength at each of the plurality of frequency ranges, with the plurality of receivers operating synchronously.

17. The method of claim 13, further comprising: in a second mode, operating two or more of the plurality of receivers to each independently sense the network signal strength at non-overlapping frequency ranges.

18. The method of claim 13, wherein the network signal strength includes a signal to noise ratio (SNR).

19. (canceled)

20. The device of claim 1, wherein the device is a portable device with a battery and a housing that houses the plurality of receivers and the plurality of antennas.

21. (canceled)

22. (canceled)

23. A non-transitory computer readable medium comprising instructions which, when executed by an apparatus, cause the apparatus to at least carry out:
obtaining a plurality of signal strengths of a common network signal sensed with a plurality of receivers coupled to a plurality of antennas comprised in the apparatus, a receiver to one or more antennas; and
determining a network signal strength based on the plurality of signal strengths.

24. (canceled)

25. (canceled)

26. (canceled)

27. (canceled)
